(19) United States
(12) Patent Application Publication
(10) Pub. No.: US 2022/0248891 A1
(43) Pub. Date: Aug. 11, 2022

(54) PROFESSIONAL ESPRESSO COFFEE MACHINE

(71) Applicant: EVOCA S.P.A., Milano (IT)

(72) Inventor: Marco Liberali, Milano (IT)

(21) Appl. No.: 17/625,956

(22) PCT Filed: Jul. 10, 2020
(86) PCT No.: PCT/IB2020/056512

§ 371 Date: Jan. 10, 2022

(30) Foreign Application Priority Data
Jul. 11, 2019 (IT) 102019000011538

(51) Int. Cl. A47J 31/00; A47J 31/36; A47J 31/52; A47J 31/46

(52) U.S. Cl. CPC A47J 31/002; A47J 31/3671; A47J 31/468; A47J 31/461; A47J 31/5255

(57) ABSTRACT

A beverage preparation machine comprising at least a brewing assembly configured to brew a beverage from a brewing substance with a brewing liquid; a brewing liquid supply circuit to supply a brewing liquid to the brewing assembly; and an electronic control unit to control operation of the beverage preparation machine.

### CROSS-REFERENCE TO RELATED APPLICATIONS

This patent application claims priority to Italian patent application no. 102019000011538 filed on Nov. 7, 2019, the entire disclosure of which is incorporated herein by reference.

### TECHNICAL FIELD OF THE INVENTION

The present invention relates in general to beverage preparation machines, in particular machine capable of brewing hot beverages from a brewing substance with pressurised hot water, such as coffee-based beverages, for example espresso coffee, instant coffee, long coffee or “fresh-brew”, etc., tea-based beverages, or barley- or other cereal-based beverages.

The present invention finds advantageous, although not exclusive, application in automatic or semi-automatic professional espresso coffee machines, to which the following description will refer for descriptive convenience without thereby losing its generality.

### STATE OF THE ART

As is known, coffee is receiving great interest by the public and the hospitality industry, also known as Ho.Re.Ca., acronym for Hotel, Restaurant, Café. The interest in this beverage has increased transversally among consumers, the signs dedicated to the flavour and the experience of this beverage have multiplied, and this despite the crises that have occurred. In fact, the consumption in the last 40 years has passed from 80 to 160 million of 60 kg coffee bags and also the Millennials have contributed towards this increase, both in the traditional markets, and in the less mature ones where the coffee sector has been developed from scratch in regions such as China or the Far East.

Today the accent of the sector is on “premiumisation”, i.e. the tendency of consumers to purchase high-priced quality products, and on “specialties”, while the espresso coffee is worth 10% of the business of the big chains.

In the field of professional espresso coffee machines there are different technologies for controlling the coffee brewing process so as to ensure a good quality of the product dispensed.

Some of these technologies are described, for example, in EP 1 867 262 B1, EP 2 313 182 B1, EP 2 313 183 B1, EP 2 575 561 B1, EP 2 642 906 B1, EP 2 991 530 B1, EP 3 364 826 A1, WO 2015/124592 A1 and US 2015/110935 A1.

In particular, WO 2015/124592 A1 discloses a coffee machine comprising at least a hydraulic brewing circuit comprising at least a water supply pump; at least a water boiler hydraulically cascade-connected to the water supply pump; at least a brewing assembly hydraulically cascade-connected to the water boiler and through which a hot water flow rate is caused to flow to carry out a brewing cycle; means for regulating the water flow rate; means for measuring the water flow rate; and a feedback controller connected to the regulation means and the measurement means and configured to real-time the current value of the water flow rate measured by the measurement means with a corresponding reference value and to control the regulation means so as to eliminate any deviation of the current value of the water flow rate with respect to the corresponding reference value of the water flow rate.

US 2015/110935 A1 is directed toward regulating flow rate in an espresso coffee machine, during a multi-phase brewing process which includes a pre-brew and an extraction phase. During the pre-brew phase, coffee grounds are slowly pre-wetted and/or out-gassed with a first volume of water delivered at a first flow rate. During the extraction phase, a second volume of water is delivered, at a second flow rate, to extract espresso, where the second volume is delivered at a generally greater pressure than the first volume. The second flow rate is greater than the first flow rate. The flow rates, volumes, and pressures are regulated by the espresso machine, which includes a flow rate regulation assembly that comprises first and second flow paths and first and second valves. Baristas may vary the flow rate, volume, and pressure of water throughout the brewing process by opening, closing, or otherwise adjusting at least one of the valves.

### OBJECT AND SUMMARY OF THE INVENTION

The Applicant has experienced that the professional espresso coffee machines described in the above-listed prior art references, although satisfactory in many respects, still have wide margins for improvement as to the control of the coffee brewing process, which is a fundamental factor for the quality of the beverages dispensed.

Therefore, the object of the present invention is to provide an improved professional espresso coffee machine compared to the known ones as to the control of the coffee brewing process.

According to the present invention, a beverage preparation machine and an electronic control therefor are provided, as claimed in the appended claims.

### BRIEF DESCRIPTION OF THE DRAWINGS

FIG. 1 is a perspective view of a professional espresso coffee machine.

FIG. 2 is a schematic view of a water supply circuit and an electronic control system of the professional espresso coffee machine.

FIG. 3 shows a profile of the water flow rate and a consequent profile of the water pressure in a water supply branch of the professional espresso coffee machine.

### DETAILED DESCRIPTION OF PREFERRED EMBODIMENTS OF THE INVENTION

The present invention will now be described in detail with reference to the accompanying figures to enable a person skilled in the art to realise it and use it. Various modifications to the described embodiments will be immediately apparent to those skilled in the art and the generic principles described can be applied to other embodiments and applications without thereby departing from the protection scope of the present invention, as defined in the appended claims. Therefore, the present invention is not to be considered as limited to the described and illustrated embodiments, but it is to be given the widest protection scope in accordance with the features described and claimed.

Unless otherwise defined, all the technical and scientific terms used herein have the same meaning commonly used by people of ordinary skill in the field pertaining to the present invention. In case of conflict, the present description, including the definitions provided, will be binding. Furthermore, the examples are provided for illustrative purposes only and as such are not to be considered limiting.

In particular, the block diagrams in the accompanying figures and described below are not to be understood as a representation of the structural features, i.e. construction limitations, but are to be interpreted as a representation of functional features, i.e. intrinsic properties of the devices and defined by the effects obtained, i.e. functional limitations, and which can be implemented in different ways, therefore so as to protect the functionalities thereof (possibility to operate).

In order to facilitate the understanding of the embodiments described herein, reference will be made to some specific embodiments and a specific lexicon will be used to describe them. The terminology used in the present document is intended to describe only particular embodiments, and is not intended to limit the scope of the present invention.

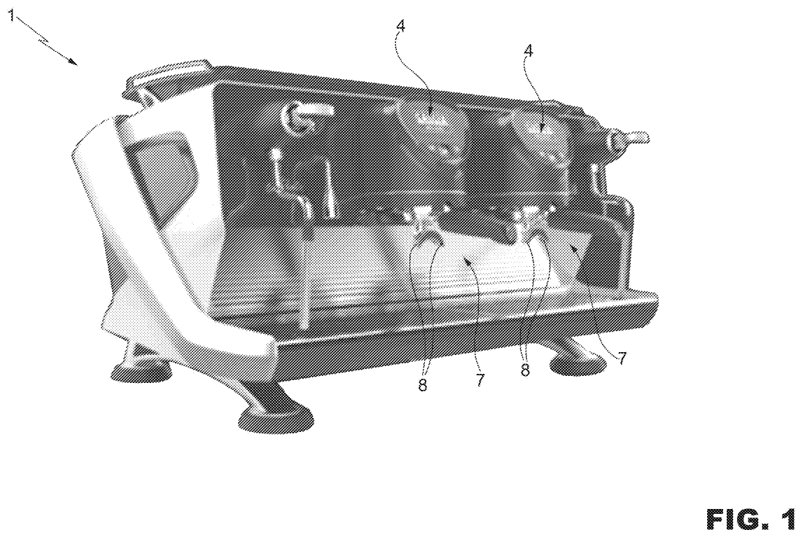

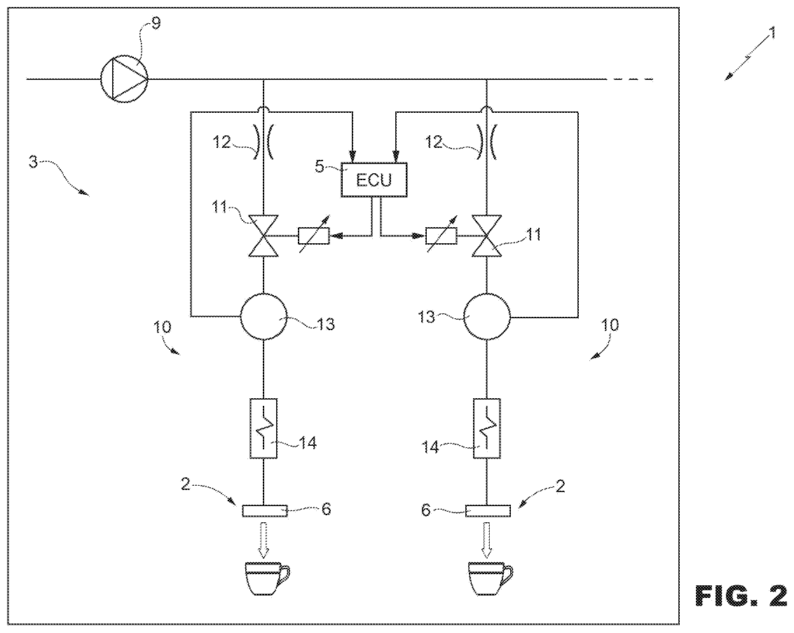

FIG. 1 shows a professional espresso coffee machine, while FIG. 2 shows a block diagram of the professional espresso coffee machine.

As is shown in FIGS. 1 and 2, the professional espresso coffee machine, referenced as a whole with reference numeral 1, comprises:
one or more brewing assemblies 2 configured to carry out the same brewing process to brew a brewing substance, in the example considered in the form of coffee powder, with a brewing liquid, in example considered in the form of pressurised hot water, so as to produce one and the same coffee-based beverage, in the example considered in the form of an espresso coffee, in either identical or different amounts, for example strong or long espresso coffees, starting from coffee powder of either one and the same or different type in terms of coffee species (arabica, robusta), coffee blend, coffee granulometry, process to which the coffee was subject, for example decaffeinated, flavoured, etc.;
a water supply circuit 3 to supply to the brewing assemblies 2 pressurised hot water necessary for preparing espresso coffee;
one or more user interfaces 4, one for each brewing assembly 2, to allow beverages to be selectable by a user; and
an electronic control unit 5 to control operation of the professional espresso coffee machine 1 in response to selections of beverages by a user.

Each brewing assembly 2 comprises:
a pressurised hot water dispenser 6 in the form of a shower head or a sprinkler, and
a filter-holder 7 with one or more espresso coffee dispensing nozzles 8 and adapted to contain, in use, coffee powder to be brewed with pressurised hot water to prepare espresso coffee and to be manually coupleable, in use, to the pressurised hot water dispenser 6 to receive pressurised hot water therefrom.

The water supply circuit 3 comprises:
a water pump 9, conveniently an electric variable-speed pump, and in the non-limiting example considered common to all the brewing assemblies 2, which may be supplied with cold water from a cold water source (not shown), which may be alternatively the public water mains or a water tank which may be housed either inside or outside, and fluidly connected to, the professional espresso coffee machine 1 and fluidly connected to the public water mains to receive cold water therefrom, and which is operable to supply pressurised cold water under pressure, and
a water supply branch 10 for each brewing assembly 2, arranged downstream of the water pump 9 and fluidly connected between the delivery of the water pump 9 and the respective brewing assembly 2 to supply pressurised hot water to the respective brewing assembly 2.

Optionally, the water supply circuit 3 may comprise a water pre-heater (not shown), conveniently a continuous-flow pre-heater, arranged downstream of the water pump 9, between the latter and the water supply branches 10, to pre-heat the water supplied to the latter.

Each water supply branch 10 comprises, in sequence, in the direction of the water flow from the water pump 9 to the respective brewing assembly 2:
a water flow rate regulation solenoid valve 11, and, optionally, a giggleur 12 arranged upstream of the water flow rate regulation solenoid valve 11, to regulate the water flow rate in the water supply branch 10; and
a water flow meter 13 to measure, and output an electrical output indicative of, the amount of water, measured in volume, supplied to the water supply branch 10; and
a water heater 14 to (further) heat the water in the water supply branch 10.

In a preferred embodiment, the water flow rate regulation solenoid valves 11 are motorised solenoid valves with electric stepper motors to allow the water flow rate to be discretely regulated.

In a different embodiment, the water flow rate regulation solenoid valves 11 are motorised solenoid valves with electric linear motors to allow the water flow rate to be substantially continuously regulated.

The electronic control unit 5 is electrically connected to the water meters 13 to receive therefrom the electrical outputs indicative of the water flow rates in the corresponding water supply branches 10, to the user interfaces 4 to receive therefrom the electrical outputs indicative of the beverage selections, and to the water pump 9, to the water flow rate regulation solenoid valves 11, to the water heaters 14, and to the water pre-heater, when provided, to output electrical commands thereto.

The electronic control unit 5 is configured to:
store one or different target water flow rate profiles FRP, each of which is associated with a respective coffee-based beverage preparable by a brewing assembly 2 and is indicative of the time development of the water flow rate Q that is intended to be supplied to the corresponding water supply branch 10 during a coffee-based beverage preparation cycle; and
closed-loop control the water flow rate regulation solenoid valves 11 based on the amounts of water measured by the water meters 13 and on the target water flow rate profiles FRP associated with the selected beverages to be dispensed.

In a preferred embodiment, the target water flow rate profiles FRP are designed to cause the water flow rate regulation solenoid valves 11 to be controlled so that in the corresponding brewing assemblies 2 at least a coffee powder pre-infusion step with a pre-infusion duration is carried out during which the current water flow rate supplied to the brewing assembly 2 follows a pre-infusion water flow rate profile, followed by at least a coffee powder infusion step with an infusion duration during which the current water flow rate supplied to the brewing assembly 2 follows an infusion water flow rate profile, whereby the switching from the pre-infusion step to the infusion step occurs on a time basis.

In this way, switching from the pre-infusion step to the infusion step, or, more in general, from a preceding (pre-)infusion step to a following (pre-)infusion step is programmed so as to occur on a time basis, at the end of the duration of the preceding (pre-) infusion step, which duration may be properly diversified, if necessary, among the various coffee-based beverages preparable by the professional espresso coffee machine 1.

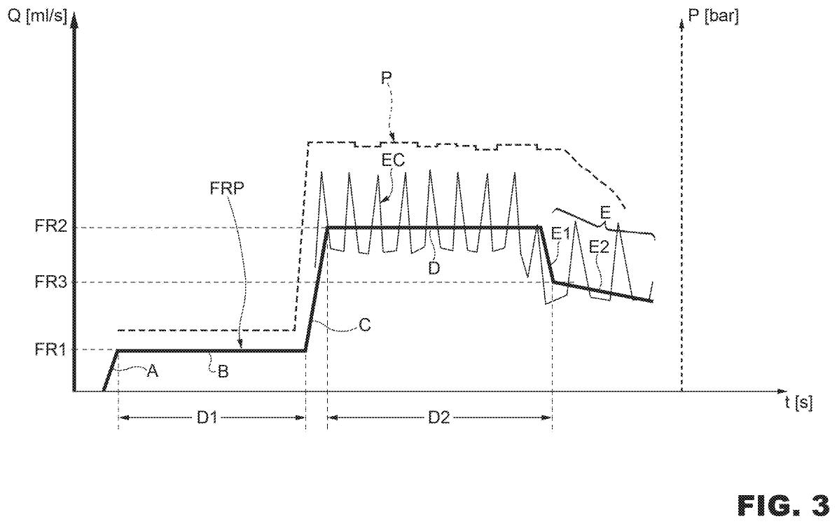

In a preferred embodiment, the stored target water flow rate profiles FRP have time developments of the type shown in FIG. 3 with a bold continuous line.

As shown in FIG. 3, a target water flow rate profile FRP has preferably, but not necessarily, a time-variable development over time according to a broken line, formed by a plurality of substantially rectilinear stretches comprising:
a first rapid rising stretch A, generally of negligible duration compared to that of the following stretches, during which the current water flow rate increases rapidly from a substantially null water flow rate to a pre-infusion water flow rate FR1,
a pre-infusion stretch B, during which the current water flow rate is substantially constant at the pre-infusion water flow rate FR1 for a pre-infusion duration D1, so as to carry out a coffee powder pre-infusion step,
a second rapid rising stretch C, during which the current water flow rate increases rapidly from the pre-infusion water flow rate FR1 to an infusion water flow-rate FR2, higher than the pre-infusion water flow rate FR1,
an infusion stretch D, during which the current water flow rate is substantially constant over time to an infusion water flow rate FR2 for an infusion duration D2, which can be equal to or different from, preferably higher than, the pre-infusion duration D1, so as to carry out a ground coffee infusion step, and
one or more falling stretches E, during which the current water flow rate decreases from the infusion water flow rate FR2 to a substantially null water flow rate.

In the embodiment shown in FIG. 3, the current water flow rate decreases from the infusion water flow rate FR2 to a null water flow rate suitably according to a straight line or a broken line comprising:
a rapid falling stretch E1, during which the current water flow rate decreases rapidly from the infusion water flow rate FR2 to an intermediate water flow rate FR3 between the infusion water flow rate FR2 and the pre-infusion water flow rate FR1, with an inclination substantially equal, but of opposite sign, to that of the second rapid rising stretch C, and
a slow falling stretch E2, during which the current water flow rate decreases slowly from the intermediate water flow rate FR3 to a substantially null water flow rate, with an inclination lower than that of the rapid failing stretch E1.

In a different embodiment not shown, the slow falling stretch E2 may be omitted and, hence, only the rapid failing stretch E1 may be provided.

In a further embodiment not shown, the target water flow rate profiles FRP may comprise additional substantially rectilinear stretches to those described above and shown in FIG. 3.

For example, the target water flow rate profiles FRP may comprise different pre-infusions stretches B with different pre-infusion water flow rates FR1 and different pre-infusion durations D1, so as to carry out different coffee powder pre-infusion steps, different infusions stretches D with different infusion water flow rates FR2 and different infusion durations D2, so as to carry out different coffee powder infusion steps, different rapid rising stretches A, C with different rapid rising inclinations, different rapid and slow falling stretches E1, E2 with different rapid and slow falling inclinations.

In a further embodiment not shown, the target water flow rate profiles FRP may have time-variable developments over time so as to define mixed lines, i.e., lines formed by substantially rectilinear stretches and curved stretches, or curved lines.

In a further embodiment not shown, the pre-infusion water flow rate FR1 and/or the infusion water flow rate FR2 may have time developments that are not constant during the pre-fusion and infusion durations D1, D2, but that vary over time according to pre-fusion and infusion water flow rate profiles.

Based on what described above and shown in FIG. 3, it may be appreciated that the target water flow rate profiles FRP and any variants thereof may be mainly characterised by the following main parameters or quantities:
the number of pre-infusion and infusion steps,
the pre-infusion and infusion water flow rate profiles in the different pre-infusion and infusion steps, and
the pre-infusion and infusion durations.

The target water flow rate profiles FRP may then also be secondarily characterised by secondary parameters or quantities, such as the developments of the transitions between the pre-infusion and infusion flow rates.

Therefore, each of the target water flow rate profiles FRP that are associated with the different coffee-based beverages preparable by the professional espresso coffee machine 1 may be conveniently stored in the electronic control unit 5 in the form of a table containing, for the different coffee-based beverages preparable by the professional espresso coffee machine 1, the main parameters and any secondary parameters which characterise the target water flow rate profiles FRP.

FIG. 3 also shows, with a dotted line, the time development of the water pressure P in a water supply branch 10 during an espresso coffee preparation cycle, which water pressure P results from the implementation of the target water flow rate profile FRP shown in FIG. 3 and depends, in addition to on the target water flow rate profile FRP, also on other factors, the main one of which is represented by the characteristics of the coffee powder contained in the brewing assemblies 2, in particular the coffee powder granulometry and compression level.

Lastly, FIG. 3 also shows, with a thinner continuous line, the time development of an electrical command EC supplied by the electronic control unit 5 to a water flow rate regulation solenoid valve 11 during a beverage preparation cycle to result in the target water flow rate profile FRP shown in FIG. 3.

The electronic control unit 5 is also programmed to control, in response to beverage selections by a user through the user interface 4, operations of the water flow rate regulation solenoid valves 11 based on the target water flow rate profiles FRP associated with the selected beverages and selected among the stored one in response to the beverage selections, so as to cause the water flow rates in the corresponding water supply branches 10 to follow the selected target water flow rate profiles FRP.

The electronic control unit 5 is conveniently programmed to closed-loop control the water flow rate regulation solenoid valves 11 implementing, for each of which, a mainly PID regulator (Proportional-Integral-Derivative) or equivalent, which receives the amount of water measured by the corresponding water meter 13 and the target water flow rate profile FRP associated with the selected beverage and supplies the corresponding water flow rate regulation solenoid valve 11 with an electrical command based on the proportional, derivative and integral terms.

From an implementative standpoint, having regard to the fact that the water meters 13 that are usually used in beverage preparation machines where beverages are brewed from brewing substances with pressurised hot water under are typically of a turbine type, i.e., where water flows through a small hydraulic turbine the rotational speed of which is proportional to the water flow rate and is measured through one or more magnets that are inserted in the turbine and are caused to pass near a magnetic sensor that responsively outputs an electrical impulse for each turbine rotation, the electrical signals outputted by the water meters 13 are of an impulsive type and hence the closed-loop control of the water flow rates in a water supply branches 10 carried out by the electronic control unit 5 amounts to a closed-loop control (of the flow cross-sections) of the water flow rate regulation solenoid valves 11 based on the frequency of the impulses of the electrical signals outputted by the water meters 13.

Based on what described above, the advantages that the present invention allows to achieve may be appreciated.

In particular, the present invention allows the water flow rates supplied to the brewing assemblies and, indirectly, the beverage brewing pressure to be profiled in a manner that is at the same time technologically simple, because it is based on a simple electronic control architecture and on a sensory system already present in the professional espresso coffee machines, and precise and reliable to implement, thus positively affecting the quality of the beverages dispensed by the professional espresso coffee machines provided with this technology.

1-9. (canceled)

10. A beverage preparation machine, comprising:
at least a brewing assembly configured to brew a beverage from a brewing substance with a brewing liquid;
a brewing liquid supply circuit to supply a brewing liquid to the brewing assembly; and
an electronic control unit to control operation of the beverage preparation machine;
wherein the brewing liquid supply circuit comprises:
a brewing liquid flow rate regulation solenoid valve to regulate the flow rate of the brewing liquid supplied to the brewing assembly; and
a brewing liquid flow meter to measure, and output an electrical output indicative of, a quantity indicative of an amount of brewing liquid supplied to the brewing assembly;
wherein the electronic control unit is electrically connected to the brewing liquid flow meter to receive the electrical output therefrom, and to the brewing liquid flow rate regulation solenoid valve to provide an electrical command thereto;
wherein the electronic control unit is configured to:
store brewing data representative of at least a target brewing liquid flow rate profile (FRP) indicative of a time development of a brewing liquid flow rate that is intended to be supplied to the brewing assembly during a beverage preparation cycle; and
closed-loop control the brewing liquid flow rate regulation solenoid valve based on the electrical output of the brewing liquid flow meter and on the target brewing liquid flow rate profile (FRP) to cause the current brewing liquid flow rate supplied to the brewing assembly to follow the target brewing liquid flow rate profile (FRP);
wherein the target brewing liquid flow rate profile (FRP) is stored in the electronic control unit as brewing data indicative of pre-infusion and infusion flow rate profiles of the brewing liquid during pre-infusion and infusion steps; the stored pre-infusion and infusion flow rate profiles comprise stored pre-infusion and infusion flow rates of the brewing liquid during the pre-infusion and infusion steps, and stored pre-infusion and infusion durations of the pre-infusion and infusion steps; and
wherein the target brewing liquid flow rate profile (FRP) is designed to cause the brewing liquid flow rate regulation solenoid valve to be controlled so as to carry out at least a brewing substance pre-infusion step having a stored pre-infusion duration and during which the current brewing liquid flow rate supplied to the brewing assembly follows a stored pre-infusion flow rate profile, followed by at least a brewing substance infusion step having a stored infusion duration and during which the current brewing liquid flow rate supplied to the brewing assembly follows a stored infusion flow rate profile, whereby switching from the brewing substance pre-infusion step to the brewing substance infusion step occurs at the end of the stored duration of the preceding pre-infusion step.

11. The beverage preparation machine of claim 10, wherein the target brewing liquid flow rate profile (FRP) has a time-variable development over time according to a broken line, formed by a plurality of substantially rectilinear stretches comprising:
at least a rising stretch, during which the current brewing liquid flow rate supplied to the brewing assembly increases from a substantially null flow rate to a stored pre-infusion flow rate;
at least a pre-infusion stretch, during which the current brewing liquid flow rate supplied to the brewing assembly is substantially constant at the stored pre-infusion flow rate for a stored pre-infusion duration;
at least a further rising stretch, during which the current brewing liquid flow rate supplied to the brewing assembly increases from the stored pre-infusion flow rate to a stored infusion flow rate, higher than the stored pre-infusion flow rate;
at least an infusion stretch, during which the current brewing liquid flow rate supplied to the brewing assembly is substantially constant over time at the stored infusion flow rate for a stored infusion duration; and
at least a falling stretch during which the current brewing liquid flow rate supplied to the brewing assembly decreases from the stored infusion flow rate to a substantially null flow rate.

12. The beverage preparation machine of claim 10, wherein the electronic control unit is configured to store a plurality of target brewing liquid flow rate profiles (FRP) associated with corresponding beverages preparable by the beverage preparation machine.

13. The beverage preparation machine of claim 10, wherein the brewing liquid flow meter is arranged downstream of the brewing liquid flow rate regulation solenoid valve.

14. The beverage preparation machine of claim 10, wherein the brewing liquid supply circuit further comprises a brewing liquid heater arranged downstream of the brewing liquid flow meter.

15. The beverage preparation machine of claim 10, wherein the brewing liquid supply circuit further comprises a brewing liquid pump to supply the brewing liquid along the brewing liquid supply circuit.

16. The beverage preparation machine of claim 10, wherein the brewing liquid flow rate regulation solenoid valve is a motorised solenoid valve with an electric stepper motor operable to allow the brewing liquid flow rate supplied to the brewing assembly to be discretely regulated.

17. The beverage preparation machine of claim 10, further comprising a plurality of brewing assemblies;
wherein the brewing liquid supply circuit further comprises:
a plurality of brewing liquid supply branches, one for each brewing assembly, to supply the brewing liquid to the brewing assemblies; and
a brewing liquid pump, common to all the brewing assemblies, to supply the brewing liquid to the brewing liquid supply branches.
